(19) United States
(12) Patent Application Publication
(10) Pub. No.: US 2013/0168891 A1
(43) Pub. Date: Jul. 4, 2013

(54) PASTE COMPOSITION FOR ARTIFICIAL MARBLE AND METHOD OF MANUFACTURING ARTIFICIAL MARBLE USING THE SAME

(71) Applicants: Chang Hwan Park, Chungcheongbuk-do (KR); Jeong Ho Jeong, Gyeonggi-do (KR)

(72) Inventors: Chang Hwan Park, Chungcheongbuk-do (KR); Jeong Ho Jeong, Gyeonggi-do (KR)

(73) Assignee: LG HAUSYS, LTD., Seoul (KR)

(21) Appl. No.: 13/814,388

(22) PCT Filed: Aug. 19, 2011
(86) PCT No.: PCT/KR11/06114

§ 371 Date: Feb. 5, 2013

(51) Int. Cl. C04B 14/04

(52) U.S. Cl. CPC C04B 14/041
USPC 264/71; 106/681

(57) ABSTRACT

The present invention relates to a paste composition for artificial marble and a method of manufacturing the artificial marble using the same, which can solve the problems of efflorescence and durability in the existing cementitious marble and the problems of thermal resistance and acid tolerance in the existing organic binder-based marble, and can provide an insulating function to the artificial marble by using an inorganic binder such as an amorphous activated aluminosilicate compound and also using a lightweight particulate porous inorganic material. The method of manufacturing the artificial marble includes preparing paste for artificial marble by mixing 10˜20 parts by weight of white cement, 3˜10 parts by weight of amorphous activated aluminosilicate, 40˜70 parts by weight of broken-stone chip, 5˜10 parts by weight of water, 0.1˜1 part by weight of water-reducing agent and 10˜30 parts by weight of lightweight particulate porous inorganic material; pouring and vibration-molding the paste in a mold; curing the paste; inducing a hydrothermal reaction of cured artificial marble at high temperature and high pressure; and machining cured product.

### TECHNICAL FIELD

The present invention relates to a paste composition for manufacturing artificial marble which is used as a structural exterior or interior material, and a method of manufacturing the artificial marble using the same, and more particularly, to a paste composition for artificial marble and a method of manufacturing the artificial marble using the same, which can solve problems of efflorescence and durability in existing cementitious marble and problems of thermal resistance and acid tolerance in existing organic binder-based marble using an inorganic binder such as an amorphous activated aluminosilicate compound.

### BACKGROUND ART

Artificial stone contrasted with natural stone means artificially manufactured stone. The artificial stone such as artificial marble and artificial granite is mainly used as a structural exterior or interior material.

The most representative artificial stone is cementitious artificial stone. The cementitious artificial stone is manufactured with a low price and typically used as a structural interior material. However, the cementitious artificial stone has a disadvantage in that its durability is deteriorated according to a change in temperature.

Further, in the cementitious artificial stone, a soluble alkaline compound or calcium hydroxide component which is generated by a hydration reaction when curing the cement is extracted through pores to a surface of the artificial stone by a capillary phenomenon, or reacted with carbon dioxide in the air so that insoluble calcium carbonate is generated and thus efflorescence occurs. Therefore, in case that the cementitious artificial stone is used as the structural exterior material for a long time period, the appearance may be damaged seriously. Thus, the use of the cementitious artificial stone as the structural exterior material has been generally rejected.

In addition, in order to restrain the efflorescence which is the problem in the cementitious artificial stone, there has been proposed organic binder-based artificial stone in which a part of cement is substituted with an organic polymer. However, in case of the organic binder-based artificial stone, it has some problems in thermal resistance, acid tolerance and surface hardness, and thus it cannot be still used as the structural exterior material.

### DISCLOSURE OF INVENTION

### Technical Problem

An object of the present invention is to provide a paste composition for artificial marble and a method of manufacturing the artificial marble using the same, which can solve the problems of efflorescence and durability in the existing cementitious marble and the problems of thermal resistance and acid tolerance in the existing organic binder-based marble, and can provide an insulating function to the artificial marble by using an inorganic binder such as an amorphous activated aluminosilicate compound and also using a lightweight particulate porous inorganic material.

### Solution to Problem

To achieve the object of the present invention, the present invention provides a paste composition for manufacturing artificial marble, which is composed of 10˜20 parts by weight of white cement, 3˜10 parts by weight of amorphous activated aluminosilicate, 40˜70 parts by weight of broken-stone chip, 5˜10 parts by weight of water, 0.1˜1 part by weight of water-reducing agent and 10˜30 parts by weight of lightweight particulate porous inorganic material.

Further, the present invention provides a method of manufacturing the artificial marble includes preparing paste for artificial marble by mixing 10˜20 parts by weight of white cement, 3˜10 parts by weight of amorphous activated aluminosilicate, 40˜70 parts by weight of broken-stone chip, 5˜10 parts by weight of water, 0.1˜1 part by weight of water-reducing agent and 10˜30 parts by weight of lightweight particulate porous inorganic material; pouring and vibration-molding the paste in a mold; curing the paste; inducing a hydrothermal reaction of cured artificial marble at high temperature and high pressure; and machining cured product.

### Advantageous Effects of Invention

According to the present invention, it is possible to prevent the efflorescencethe efflorescence by using the inorganic binder such as amorphous activated aluminosilicate. Further, since the lightweight particulate foram inorganic material having the low specific gravity is applied when performing the vibration molding process, the lightweight particulate foram inorganic material floats to the upper side and forms a desired layer, thereby providing the insulating function.

### BRIEF DESCRIPTION OF DRAWINGS

The above and other objects, features and advantages of the present invention will become apparent from the following description of preferred embodiments given in conjunction with the accompany drawings, in which:

FIG. 1 is a flow chart showing a method of manufacturing artificial marble according to the present invention.

FIG. 2 is a view showing a comparative example of artificial marble in which an amorphous activated aluminosilicate compound and a lightweight particulate porous inorganic material are not used.

FIG. 3 is a view showing two layers in which broken-stone chip having a high specific gravity sinks to a bottom of the mold and lightweight particulate porous inorganic material chip having a low specific gravity floats to a surface of the mold.

### BEST MODE FOR CARRYING OUT THE INVENTION

Hereinafter, the embodiments of the present invention will be described in detail.

A paste composition for artificial marble of the present invention is composed of white cement, amorphous activated aluminosilicate, broken-stone chips, water, water-reducing agent, and lightweight particulate porous inorganic material.

The white cement functions as a basic binder, and 10˜20 parts by weight of the white cement is added. If the content thereof is less than 10 parts by weight, the strength thereof is lowered after a hydration reaction of the cement. And if the content thereof is more than 20 parts by weight, the manufacturing cost is increased and also the efflorescence is occurred by the excess cement.

The amorphous activated aluminosilicate is used as an inorganic binder. Metakaolin, fly ash, diatomite, silica fume and the like can be used alone or in combination of two or more thereof. Preferably, 3˜10 parts by weight of the amorphous activated aluminosilicate is contained in the paste composition. If the content is less than 3 parts by weight, it is not possible to prevent the efflorescence, and also since it is impossible to effectively form an aluminosilicate polymer having a three dimensional network structure, the strength may be deteriorated. However, if the content is more than 10 parts by weight, a hardness of the artificial marble is lowered, and thus it cannot be used as a structural exterior material. The metakalon is obtained by thermally treating kaolin at a temperature of 600° C.˜900° C. and then activating it.

The broken-stone chip is obtained by grinding natural stone such as marble, serpentine and granite or artificial stone and contains fine powder of silica stone or natural stone. The broken-stone chip is a basic material of the artificial marble, and functions to provide a hardness to the artificial marble.

Preferably, 40˜70 parts by weight of the broken-stone chip is contained in the paste composition. If the content is less than 40 parts by weight, a hardness of the artificial marble is deteriorated and thus the artificial marble cannot be used as the structural exterior material. Further, since the aggregate is not appeared externally, it is not possible to provide fine appearance. If the content is more than 70 parts by weight, a relative content of the inorganic binder is lowered, and thus the strength of the artificial marble is deteriorated. And when mixing with other materials for the paste composition, workability is also deteriorated.

As the lightweight particulate porous inorganic material (having a diameter of 0.2˜1 mm), foam glass of low specific gravity is used to obtain insulation effect. Herein, it is further advantageous in providing of the insulation effect that the specific gravity is 0.3˜0.8, preferably 0.3˜0.5. A content of the lightweight particulate porous inorganic material is 10˜30 parts by weight. If the content is less than 10 parts by weight, the insulation effect is insignificant, and if the content is more than 30 parts by weight, there is a problem in mixing.

In order to achieve an extent of the above-mentioned specific gravity, it is preferable that the glass foaming is performed at a temperature of 700˜800° C. If the glass foaming is performed at a temperature of 800° C. or more, the specific gravity is increased, and thus it is not preferable.

5˜10 parts by weight of water is used, and various water-reducing agents can be used, such as naphthalene-based, melamine-based and polycarboxylic acid-based water-reducing agent, but the present invention is not limited to these. The polycarboxylic acid-based water-reducing agent is mainly used. Preferably, a content of the water-reducing agent is 0.1˜1 part by weight.

For the paste mixed with the above-mentioned materials, various reactions such as a dissolution reaction of aluminosilicate, a polymerization reaction by recombination of aluminosilicate, and a coupling reaction of calcium with silicate are performed simultaneously or in order according to reaction conditions and composition ratios. In the dissolution reaction of aluminosilicate, Aluminium ions and silicon ions on a surface of the amorphous activated aluminosilicate compound such as metakaolin and fly ash are dissolved in a strong alkali solution, and thus tetrahedral aluminate(AlO₄), silicate(SiO₄) and oligosialate formed by coupling aluminate and silicate are formed.

The ions formed by the dissolution reaction of aluminosilicate form polysialate through a polymerization reaction which is a recombination reaction of oligosialate under an alkaline catalyst condition. The polymerization reaction of oligosialate forms a monomer such as Si—O—Al—O—, Si—O—Al—O—Si—O— and Si—O—Al—O—Si—O—Si—O— according to the composition ratios of aluminium ions and silicon ions and the reaction conditions, and thus forms a polymer type high strength structure having the three dimensional network structure.

Because the aluminosilicate polymer has the three dimensional network structure, it has structural stability at a high temperature. Further, since it has an accelerated early strength development, it is possible to reduce the manufacturing time. Furthermore, the aluminosilicate polymer is cured at a low temperature and it leads to low energy consumption. In addition, since it is formed of mineral materials, it can be used as an eco-friendly material.

Meanwhile, some ions of the silicate dissolved in the aluminosilicate is reacted with calcium hydroxide to form calcium silicate hydrate. Also, the ions form a crystalline material such as tobermorite or a semi-crystalline material.

Therefore, according to the paste composition of the present invention, it is possible to increase the content of aluminosilicate as the inorganic binder and also to reduce the porosity, and thus it is possible to achieve the properties of high strength and water-tightness.

The paste mixed with the above-mentioned ratio passes through pouring and vibration molding processes in a mold, a curing process, a hydrothermal reaction process and a machining process in order to manufacture the artificial marble.

In other word, 10˜20 parts by weight of white cement, 3˜10 parts by weight of amorphous activated aluminosilicate, 40˜70 parts by weight of broken-stone chip, 5˜10 parts by weight of water, 0.1˜1 part by weight of water-reducing agent and 10˜30 parts by weight of lightweight particulate porous inorganic material are mixed so as to prepare the paste, and the paste is poured into the mold. The mold functions to determine a shape of the artificial marble to be manufactured. Herein, a release material may be previously coated on an inner surface of the mold so that the artificial marble is easily separated from the mold after the curing process.

In the vibration molding process, the vibration is applied to the mold for about 30 seconds ˜3 minutes at 1000˜3500 rpm so that the broken-stone chip having a high specific gravity sinks to a bottom of the mold and the lightweight particulate porous inorganic material chip floats to a surface of the mold due to a difference in specific gravities thereof, thereby forming two layers.

Preferably, the curing process is performed twice with a steam curing process and a high pressure and high temperature steam curing process. In the steam curing process which cures the paste for artificial marble, the paste composition is gradually hardened to form the artificial marble. The curing is performed for 12˜36 hours at a temperature of 0° C.˜150° C. and a relative humidity of 65% or more. In the high pressure and high temperature steam curing process, the hydrothermal reaction of a molding is induced in an autoclave for 5˜10 hours at a pressure of about 10 bar, thereby generating a pozzolanic reaction.

The machining process includes a polishing process, a surface-treating process and the like. Surfaces of the molded artificial marble are properly cut and then treated by the polishing process so as to have a gloss. According to circumstances, initial staining property is maximized through the surface treating process.

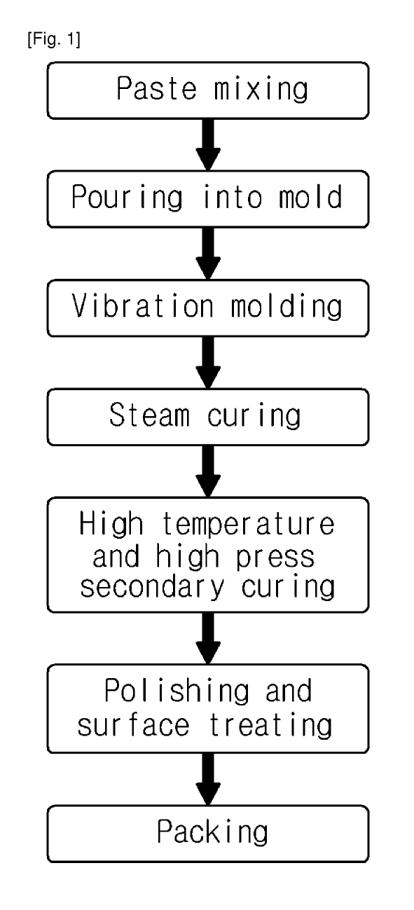

FIG. 1 is a flow chart showing a method of manufacturing artificial marble according to the present invention, in which the method includes a step of preparing paste for the artificial marble, a pouring step, a vibration molding step, a steam curing step, a high pressure and high temperature secondary curing step, and a polishing and surface treating step.

### MODE FOR THE INVENTION

Hereinafter, the embodiments of the present invention will be described in detail with reference to accompanying drawings. However, the present invention is not limited to embodiments to be described below.

### Embodiment

### Invention Example

parts by weight of white cement, 6 parts by weight of metakaolin (Pozzolanicreactivity 950 min, a size of 300 Mesh or less, white), 50 parts by weight of broken-stone chip, 17 parts by weight of lightweight particulate porous inorganic material (a diameter of 0.7 mm, foam glass which is calcinated at a temperature of about 800° C. so as to have a specific gravity of 0.3), 8 parts by weight of water, and 0.5 part by weight of water-reducing agent (polycarboxylic acid-based water-reducing agent) are mixed to prepare an inorganic binder. The inorganic binder is poured into a mold and then treated by a vibration molding process (3,500 rpm, about 3 minutes), thereby forming a molding.

When visually observing the formed molding, the broken-stone chip sinks to a bottom of the mold and lightweight particulate porous inorganic material chip having a low specific gravity floats to a surface of the mold, thereby forming two layers (referring to FIG. 3).

The molding is cured for 24 hours at a temperature of 60° C. and a relative humidity of 98%, thereby manufacturing artificial marble. The artificial marble is secondarily cured by a hydrothermal reaction which is induced in an autoclave for 10 hours at a pressure of 10 bar and a temperature of about 180° C. Then the artificial marble passes through side-cutting, polishing and surface-treating process, thereby manufacturing the artificial marble having the insulating function. The manufactured artificial marble is shown in FIG. 3.

### Comparative Example

24.5 parts by weight of white cement, 67 parts by weight of broken-stone chip, 8 parts by weight of water, and 0.5 part by weight of water-reducing agent are mixed to prepare an inorganic binder. The inorganic binder is poured into a mold and then treated by a vibration molding process (3,500 rpm, about 3 minutes), thereby forming a molding.

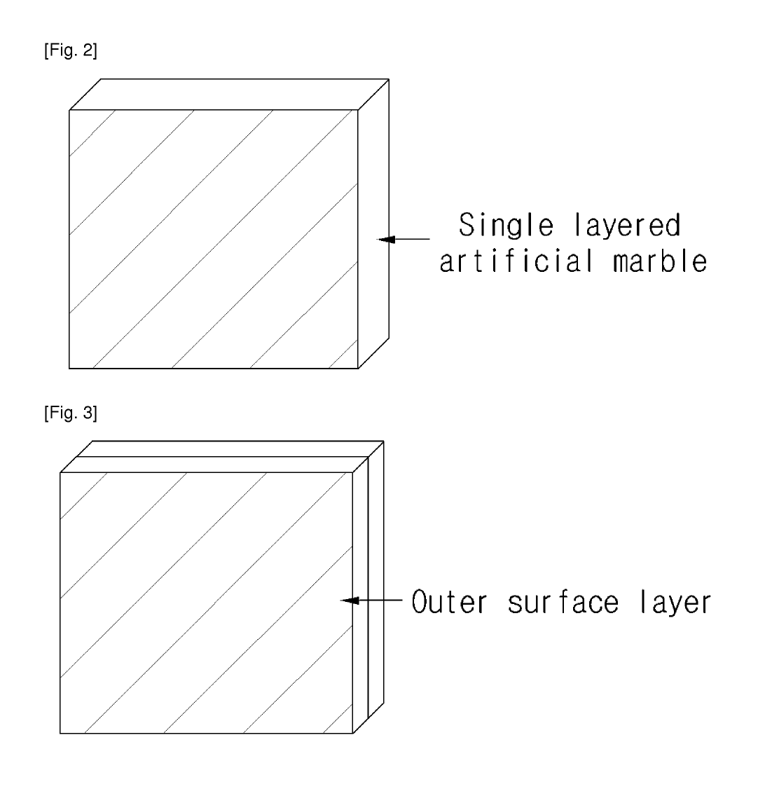

The molding is cured for 24 hours at a temperature of 60° C. and a relative humidity of 98%, thereby manufacturing artificial marble. The artificial marble passes through side-cutting, polishing and surface-treating process, thereby manufacturing the artificial marble having the insulating function. The manufactured artificial marble is shown in FIG. 2.

Measurement of Physical Properties and Estimation

Physical properties of the manufacture artificial marble according to the invention example and the comparative example are measured with respect to three point flexural strength, heat conductivity and water absorptance, and the results thereof are indicated in table 1

The measurement of three point flexural strength is based on KS F4035.

The measurement of heat conductivity is based on KS L9016.

The measurement of water absorptance is based on KS F2530.

TABLE 1

| | Flexural | Heat con- | Water ab- |
|---|---|---|---|
| | strength | ductivity | sorptance |
| | (Mpa) | (kcal/mh ° C.) | (%) |
| Comparative | 11 | 0.2 | 3.3 |
| example | | | |
| Invention example | 15 | 0.06 | 2.1 |

As indicated in table 1, since the artificial marble of the invention example containing the amorphous activated aluminosilicate and lightweight particulate porous inorganic material can secure higher densification than that of the comparative example, it has a higher flexural strength and a lower absorptance. Further, as shown in FIG. 3, since the artificial marble containing the lightweight particulate porous inorganic material has a layer of the lightweight particulate porous inorganic material at one surface thereof, it is possible to reduce the heat conductivity and thus to provide the insulating function.

While the present invention has been described with respect to the specific embodiments, it will be apparent to those skilled in the art that various changes and modifications may be made without departing from the spirit and scope of the invention as defined in the following claims.

### INDUSTRIAL APPLICABILITY

According to the present invention, it is possible to prevent the efflorescencethe efflorescence by using the inorganic binder such as amorphous activated aluminosilicate. Further, since the lightweight particulate foram inorganic material having the low specific gravity is applied when performing the vibration molding process, the lightweight particulate foram inorganic material floats to the upper side and forms a desired layer, thereby providing the insulating function.

1. A paste composition for manufacturing artificial marble, which is composed of 10˜20 parts by weight of white cement, 3˜10 parts by weight of amorphous activated aluminosilicate, 40˜70 parts by weight of broken-stone chip, 5˜10 parts by weight of water, 0.1˜1 part by weight of water-reducing agent and 10˜30 parts by weight of lightweight particulate porous inorganic material.

2. The paste composition for manufacturing artificial marble according to claim 1, wherein the paste composition passes through a dissolution reaction of aluminosilicate, a polymerization reaction by recombination of aluminosilicate, and a coupling reaction of calcium with silicate.

3. The paste composition for manufacturing artificial marble according to claim 1, wherein the amorphous activated aluminosilicate is one, or two or more selected from metakaolin, fly ash, diatomite and silica fume.

4. The paste composition for manufacturing artificial marble according to claim 1, wherein the lightweight particulate porous inorganic material is foam glass having a low specific gravity.

5. A method of manufacturing artificial marble, comprising:
preparing paste for artificial marble by mixing 10˜20 parts by weight of white cement, 3˜10 parts by weight of amorphous activated aluminosilicate, 40˜70 parts by weight of broken-stone chip, 5˜10 parts by weight of water, 0.1˜1 part by weight of water-reducing agent and 10˜30 parts by weight of lightweight particulate porous inorganic material;
pouring and vibration-molding the paste in a mold;
curing the paste;
inducing a hydrothermal reaction of cured artificial marble at high temperature and high pressure; and
machining cured product.

6. The method according to claim 5, wherein the vibration molding is performed in the mold for 30 seconds ˜3 minutes at 1,000˜3,500 rpm so that the broken-stone chip sinks to a bottom of the mold and the lightweight particulate porous inorganic material chip having a low specific gravity floats to a surface of the mold, thereby forming two layers.

7. The method according to claim 5, wherein the amorphous activated aluminosilicate is one, or two or more selected from metakaolin, fly ash, diatomite and silica fume.

8. The method according to claim 5, wherein the lightweight particulate porous inorganic material is foam glass having a low specific gravity.
